(19) United States
(12) Patent Application Publication
(10) Pub. No.: US 2009/0195195 A1
(43) Pub. Date: Aug. 6, 2009

(54) Position Feedback Device for a Linear Motor

(76) Inventor: LIEH-FENG HUANG, Taichung (TW)

Correspondence Address: Dr. BANGER SHIA, 102 Lindencrest Ct., Sugar Land, TX, 77479-5201, US

(21) Appl. No.: 12/025,042

(22) Filed: Feb. 3, 2008

(51) Int. Cl. H02K 11/00; H02K 41/02

(52) U.S. Cl. 318/135

(57) ABSTRACT

A position feedback device for a linear motor comprises three linearly-arranged Hall sensors. The three Hall sensors are connected to a mover, respectively. The direction in which the Hall sensor in the middle of the three Hall sensors is reverse to the direction in which the other two Hall sensors of the three Hall sensors are connected, so that the arrangement distance of the three Hall sensors can be reduced, and the size of the position feedback device can be reduced.

### BACKGROUND OF THE INVENTION

1. Field of the Invention

The present invention relates to a motor propulsion system capable of moving linearly, and more particularly to a position feedback device for a linear motor.

2. Description of the Prior Art

As for a linear motor, it comprises a plurality of pairs of magnetic poles that are linearly arranged to form a stator. Each pair of magnetic poles consists of an N pole and an S pole. By changing the direction of the electric current of the coil in a mover, it can control the magnetic direction of the mover, so that the mover can linearly move along the stator. As for a three-phase linear motor, the mover is disposed with three linearly-arranged coils therein, and the three coils and the magnetic poles of the stator are arranged in the same direction.

Conventionally, in order to fully understand the relative position relationship between the stator and the mover to enable the user to input correct driving motor angles when starting the linear motor, as shown in FIG. 1, the mover W is disposed with a position feedback device H which includes three linearly-arranged Hall sensors H1, H2 and H3. The direction in which the three Hall sensors are arranged is the same as the direction in which the N-pole A2 and the S-pole A3 of the pair of magnetic poles A1 of the stator are arranged. The three Hall sensors H1, H2 and H3 are positioned correspondingly to the three coils (not shown) of the mover W. For the linear motor is a three-phase motor, after the waveform W of the mover cooperates with the position feedback device H and one pair of magnetic poles A1 as shown in FIG. 2, the oscilloscope shows that there are three sinusoidal waves W1, W2 and W3. The angle of the pair of magnetic poles A1 is 360 degrees. The phase differences of the two adjacent sinusoidal waves W1, W2 and W2, W3 of the three sinusoidal waves W1, W2 and W3 are both 120 degrees. The angles of the three sinusoidal waves W1, W2 and W3 with respect to A1 are a, a+120 degrees and a+240 degrees, respectively. The three Hall sensors H1, H2 and H3 are connected clockwise to correspond to the three coils of the mover W, so as to sense the three sinusoidal waves W1, W2 and W3, and the relative positions of the respective Hall sensors H1, H2 and H3 to the respective sinusoidal waves W1, W2 and W3 must be the same, so the distances between the two adjacent Hall sensors H1, H2 and H2, H3 must correspond to the phase difference 120 degrees. By conversion, if the length of A1 is L, the distance corresponding to the phase difference 120 degrees is L/3, so after the position feedback device H ignores the some lengths of the three Hall sensors H1, H2 and H3, its size is just the summation of the distance between the two adjacent Hall sensors H1, H2 and the distance between the two adjacent Hall sensors H2, H3, namely, 2 L/3.

The present invention has arisen to mitigate and/or obviate the afore-described disadvantages.

### SUMMARY OF THE INVENTION

The primary objective of the present invention is to provide a position feedback device for a linear motor, the size of which can be reduced by counterclockwise connecting the Hall sensor in the middle of the three linearly-arranged Hall sensors.

In order to achieve the above objective, the position feedback device of the present invention comprises three Hall sensors that are equidistantly linearly arranged, and the direction in which the Hall sensor in the middle of the three Hall sensors is connected is reverse to the direction in which the other two Hall sensors of the three Hall sensors are connected.

By such arrangements, the relative distance between the two Hall sensors which are located at both ends of the three Hall sensors can be reduced, thus greatly reducing the size of the position feedback device.

### BRIEF DESCRIPTION OF THE DRAWINGS

FIG. 1 is a schematic view showing that a conventional position feedback device is disposed on a three-phase linear motor;

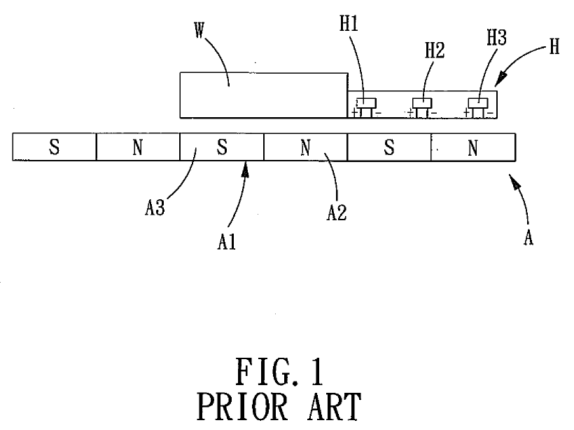

FIG. 2 shows that the conventional position feedback device senses the sinusoid waves of the mover;

FIG. 3 is a schematic view showing that a position feedback device in accordance with the present invention is disposed on a three-phase linear motor; and

FIG. 4 is a schematic view showing how to adjust the position of the Hall sensors to reduce the size of the position feedback device in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

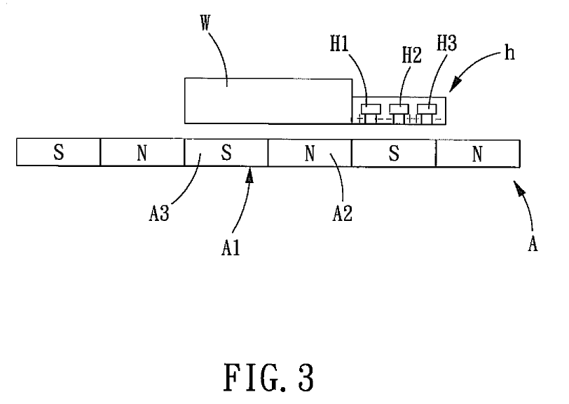

Referring to FIG. 3, a position feedback device h for a linear motor in accordance with the present invention is connected with a mover W. The mover W is correspondingly disposed on a stator A that is formed by linearly arranging a plurality of pairs of magnetic poles A. Each pair of magnetic poles A1 consists of an N-pole A2 and an S-pole A3. The position feedback device h comprises three Hall sensors H1, H3 and H2 that are equidistantly linearly arranged in order. The distance between the two Hall sensors H1 and H2 which are located at both ends of the three Hall sensors H1, H2 and H3 is one third of the length of a pair of magnetic poles A, and the two Hall sensors H1 and H2 are connected clockwise, while the Hall sensor H3 in the middle of the three Hall sensors H1, H2 and H3 is connected counterclockwise.

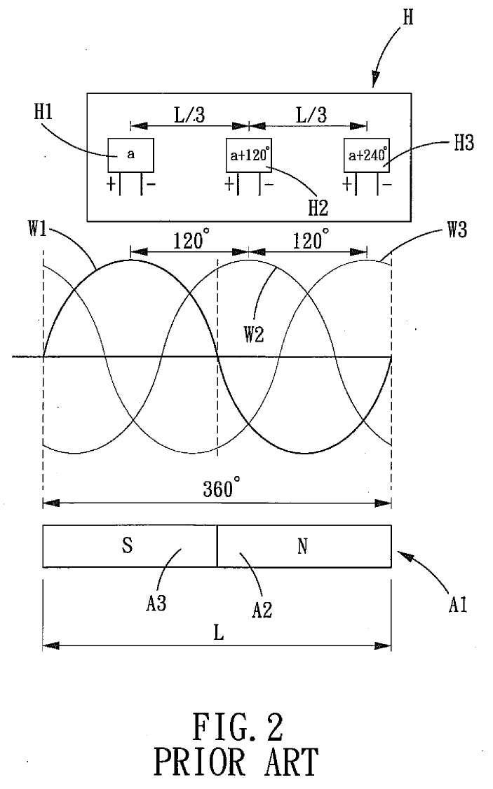

As known from FIG. 2, the distances between the two adjacent Hall sensors H1, H2 and H2, H3 of the conventional three Hall sensors H1, H2 and H3 both corresponds to the phase difference 120 degrees. Under the condition that an angle of one pair of magnetic poles A1 is 360 degrees, the distance of each of the two adjacent Hall sensors H1, H2 and H2, H3 is L/3, so the distance between the two Hall sensors that are located at both ends of the three Hall sensors H1, H2 and H3 is 2 L/3.

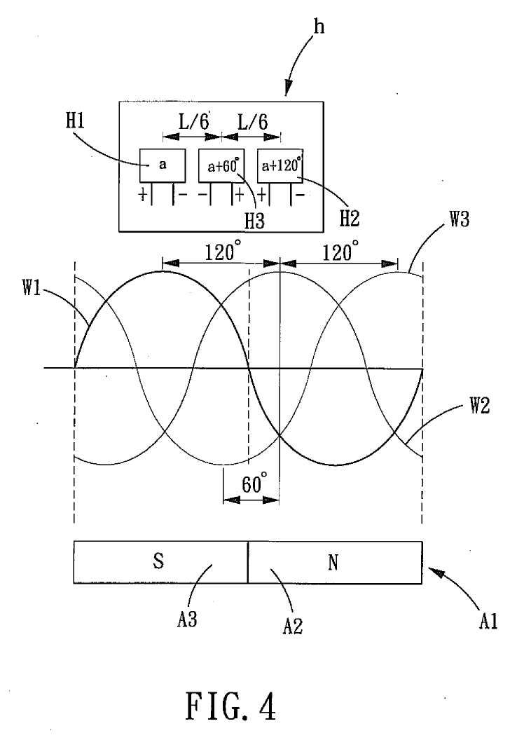

Hence, for reducing the size of the position feedback device, in the fabrication of the present invention, the Hall sensor H3 on one end of the position feedback device H is connected counterclockwise first, and the displacement of the counterclockwise connected Hall sensor H3 relative to the pair of magnetic poles A1 is a distance corresponding to the phase difference 180 degrees, that is, L/2, the distance of the displacement of the two Hall sensors H1, H2. The position of the counterclockwise connected Hall sensor H3 relative to the pair of magnetic poles A1 is a+60 degrees. After the counterclockwise connected Hall sensor H3 moves, it will be located between the two Hall sensors H1, H2, thus forming the position feedback device of the present invention. Moreover, the distance between the counterclockwise connected Hall sensor H3 and each of the two Hall sensors H1, H2 is L/6, and the position feedback device h senses the three sinusoid waves W1, W2 and W3 as shown in FIG. 4. The phase differences between the two adjacent sinusoidal waves W1, W2 and W2, W3 of the three sinusoidal waves W1, W2 and W3 are still 120 degrees, so that the motor angle will not be affected and changed, and under the condition of correctly sensing the motor angle of the linear motor, the length of the position feedback device h can be reduced.

While we have shown and described various embodiments in accordance with the present invention, it is clear to those skilled in the art that further embodiments may be made without departing from the scope of the present invention.

What is claimed is:

1. A position feedback device for a linear motor, being connected with a mover, the mover being correspondingly disposed on a stator which is formed by linearly arranging a plurality of pairs of magnetic poles, each pair of magnetic pole consisting of an N pole and an S pole, the position feedback device comprising three Hall sensors which are linearly arranged, a direction in which a Hall sensor in the middle of the three Hall sensors being connected is reverse to a direction in which the other two Hall sensors of the three Hall sensors are connected.

2. The position feedback device for a linear motor as claim in claim 1, wherein the Hall sensor in the middle of the three Hall sensors is counterclockwise connected, and the other two Hall sensors of the three Hall sensors is clockwise connected.

3. The position feedback device for a linear motor as claim in claim 1, wherein the three Hall sensors are equidistantly arranged.

4. The position feedback device for a linear motor as claim in claim 1, wherein a distance between the two Hall sensors which are located at both ends of the three Hall sensors are one third of a length of a pair of magnetic poles.
